(19) United States
(12) Patent Application Publication
(10) Pub. No.: US 2006/0127672 A1
(43) Pub. Date: Jun. 15, 2006

(54) Method of providing a heat spreader

(76) Inventors: Gregory M. Chrysler, Chandler, AZ (US); Abhay A. Watwe, Chandler, AZ (US); Ravi V. Mahajan, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/355,698

(22) Filed: Feb. 15, 2006

Related U.S. Application Data
(63) Continuation of application No. 10/074,043, filed on Feb. 14, 2002, now abandoned.

(51) Int. Cl. B32B 9/00

(52) U.S. Cl. 428/408

(57) ABSTRACT

A method of preparing a diamond body, and a diamond body thus prepared. A covering layer is provided on at least one surface of the diamond body such that the covering layer adheres to the at least one surface. The covering layer is in turn provided with a predetermined configuration.

### BACKGROUND OF THE INVENTION

The instant invention pertains to methods of processing diamond layers, in particular for use as diamond integrated heat spreaders.

Diamond layers are used in applications such as heat spreader packages. Stand-alone diamond wafers and diamond integrated heat spreaders are typically used to help cool laser diodes and some power transistors. It is recognized in the art that diamond layers can be produced by chemical vapor deposition, or CVD. For many applications, including the use of diamond heat spreaders in microelectronic packages, it becomes necessary to remove material from the diamond layer.

CVD diamond layers typically exhibit a rough surface that would require polishing the diamond layer in order to provide a smooth surface for further processing, such as for incorporation of the polished diamond layer into a heat spreader package. Polishing a diamond layer enhances the thermal performance of a diamond integrated heat spreader by improving the heat transfer from the diamond. Smoother surfaces on the diamond will result in a thinner thermal interface material bond line thickness which will reduce the thermal resistance of the diamond heat spreader. By “bond line thickness,” what is meant is the average thickness of the thermal interface material, or the average separation distance between the two surfaces being thermally coupled by the thermal interface material. To the extent that diamond exhibits extreme hardness, known mechanical means for polishing the surface of the diamond layer can be both costly and time consuming.

U.S. Pat. No. 6,197,375 describes a method of polishing a diamond layer by contacting the film with metal, such as Fe, Ni, Mn and Ti, and by maintaining the metal-contacted diamond layer at an effective temperature, such as between 600-1100 degrees Centigrade, for a time sufficient to result in removal of a predetermined amount of diamond from the film. Other processes for polishing the surface of a diamond layer are known, such as polishing with oxygen ions or gas, laser ablation, argon ion beam irradiation, and electrical discharge.

None of the existing processes for polishing a diamond layer, however, are fully satisfactory in efficiently and cost-effectively providing a diamond heat spreader exhibiting a thermal coupling surface of a desirable smoothness and flatness.

### BRIEF DESCRIPTION OF THE DRAWINGS

The present invention is illustrated by way of example and not limitation in the figures in the accompanying drawings in which like references indicate similar elements, and in which:

FIG. 1 is a schematic, cross-sectional representation of a typical CVD diamond layer exhibiting a rough upper side;

FIG. 2 is a schematic representation showing the diamond layer of FIG. 1 as having been metallized on its upper side according to an embodiment of the present invention;

FIG. 3 is a schematic representation showing the metallized diamond layer of FIG. 2 as having been polished according to an embodiment of the present invention;

FIG. 4 is a schematic representation showing the polished metallized diamond layer of FIG. 3 as having been provided with a final layer according to an embodiment of the present invention;

FIG. 5 is a schematic representation showing an another embodiment of a diamond heat spreader according to embodiments of the present invention;

FIGS. 6a-6c are schematic representations each showing respective double-sided diamond heat spreaders according to embodiments of the present invention;

FIG. 7 is a schematic representation of a microelectronic package according to the prior art;

FIG. 8a is a schematic exploded cross-sectional representation of a die package and heat spreader lid incorporating a diamond heat spreader according to one embodiment of the present invention; and

FIG. 8b is a schematic exploded cross-sectional representation of a die package and heat spreader lid incorporating a diamond heat spreader according to another embodiment of the present invention.

### DETAILED DESCRIPTION

Embodiments of the present invention involve the provision, on a diamond body, of a layer made of at least one material that adheres to the diamond body, the layer being adapted to exhibit a desired configuration. In particular, one embodiment of the present invention involves the manufacturing of a diamond integrated heat spreader, or diamond heat spreader, by the provision, on a diamond body, of a thermally conductive covering layer that adheres to the diamond body, and by the provision of a thermal coupling surface for the covering layer that exhibits a predetermined roughness and flatness. The covering layer may comprise at least one metal. The predetermined roughness may be chosen for the attachment of the diamond heat spreader to a thermal interface material. One embodiment of the present invention contemplates metallizing a diamond layer to provide a metal surface of known roughness and flatness for the attachment thereof to a thermal interface material. The predetermined roughness and flatness may be achieved by polishing the layer of metal provided on the diamond layer. According to embodiments of the present invention, the thermal performance of a diamond integrated heat spreader may be enhanced by providing a process for reducing a surface roughness of a diamond integrated heat spreader to be used in a microelectronic package.

According to one embodiment of the present invention, rather than polishing the diamond layer itself, the diamond layer is first coated with a metal layer that is thick enough to allow one to polish the metal layer instead of the diamond layer to the required roughness. Diamond heat spreaders incorporating diamond layers metallized and polished according to embodiments of the present invention are less costly and more efficient to produce than diamond heat spreaders having diamond layers polished according to the prior art.

By “diamond layer,” what is meant in the context of embodiments of the present invention is a diamond body, either attached to another body or free standing, that has two dimensions, as in length and width, that are substantially larger than a third dimension, as in thickness. Embodiments of the present invention encompass the processing of both polycrystalline and single crystal diamond layers. Although single crystal diamond layers are generally smoother and have higher thermal conductivity than polycrystalline diamond layers, and are hence better suited for use as diamond heat spreaders, their cost is significantly higher than that of polycrystalline diamond layers. Thus, the use of polycrystalline diamond layers can give reduced cost.

In addition, by “diamond integrated heat spreader” or “diamond heat spreader,” what is meant in the context of embodiments of the present invention is a diamond body adapted for use in a heat spreader package as recognized by one skilled in the art. According to embodiments of the present invention, a diamond body is adapted for use in a heat spreader package by being provided thereon with a covering layer, such as a metal, that exhibits a predetermined roughness and flatness for attachment into a heat spreader package by way of a thermal interface material.

By “heat spreader package,” what is meant in the context of embodiments of the present invention is any heat dissipating package adapted for attachment to an integrated circuit or integrated circuit assembly for dissipating heat therefrom, as readily recognizable by one skilled in the art.

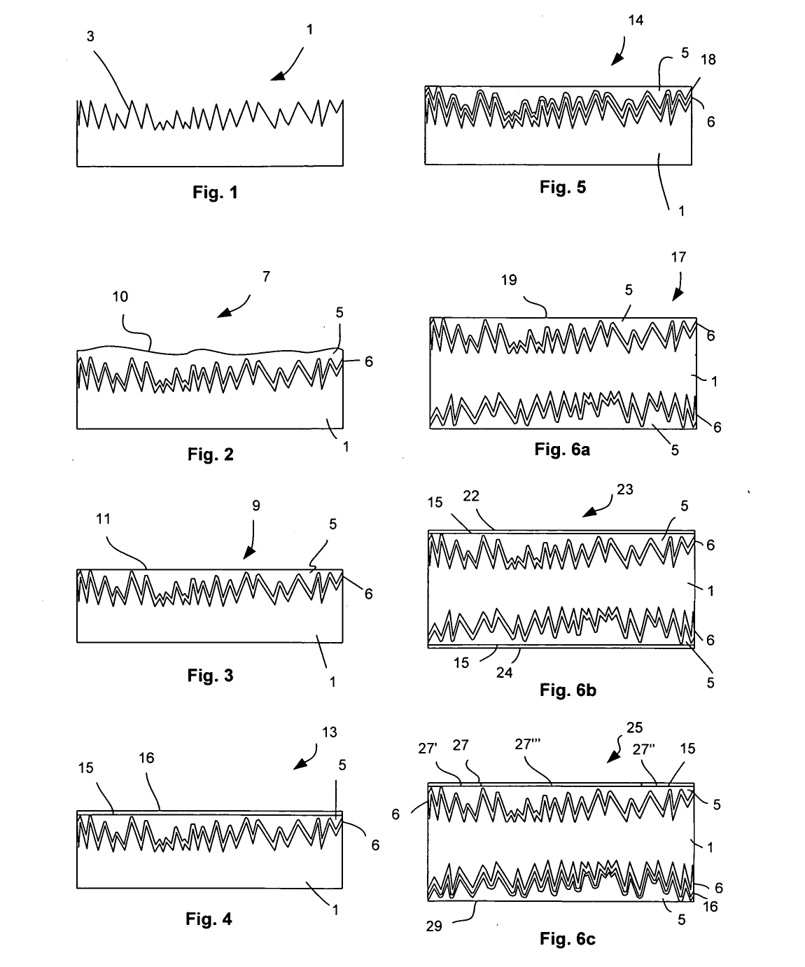

Turning next to the figures, none of which are necessarily to scale, FIG. 1 represents a CVD diamond layer 1 exhibiting a rough upper surface 3 thereon. It is noted that, although FIGS. 1-8b show a CVD diamond layer, embodiments of the present invention encompass the provision of a thermally conductive layer on a diamond body of any shape, and not necessarily of a diamond layer as defined herein. In addition, although FIGS. 1-5 show only one surface of diamond layer 1 as being processed according to an embodiment of the present invention, embodiments of the present invention encompass the processing of a diamond layer exhibiting rough surfaces on an upper side and a lower side thereof, as shown in and described further below with respect to FIGS. 6a-8b. Additionally, in the context of embodiments of the present invention, “upper” and “lower” are not meant to refer to an actual orientation of the diamond layer during processing or in a heat spreader package, but rather to the orientation of the diamond layer as shown in the figures, so that the actual diamond layer being actually processed or held in a heat spreader package may be held in any given orientation based on application needs.

The process of producing a diamond integrated heat spreader typically involves CVD of carbon onto a flat surface. The resulting diamond layer is polycrystalline. During this process the growth or free surface becomes rough owing to the growth of individual crystals. As seen in FIG. 1, rough upper surface 3 is typical of the faceting of the upper surface of a diamond layer made by CVD, where the faceting may exhibit roughly cone-shaped columnar structures. The typical roughness of a diamond layer such as the one shown in FIG. 1 is about 10% of the diamond thickness. Thus, by “roughness” for a diamond surface in the context of embodiments of the present invention, what is meant is a roughness measured as a peak to valley distance with an average of about 1 micron and a maximum of about 10 microns. For a diamond layer having a thickness of about 1.5 mm, the latter being a typical thickness of a diamond integrated heat spreader, the RMS roughness of the upper surface is usually about 150 microns. It is clear from FIG. 1 that a strongly faceted surface exhibiting significant height variations would be undesirable for use in heat spreaders. Heat transfer through the upper surface of the diamond film would be impeded by the air pockets created by virtue of the surface roughness, hence the necessity to polish the upper surface of the diamond layer.

Referring next to FIG. 2, a novel approach to providing a smooth upper surface for the diamond layer is shown according to one embodiment of the present invention. Here, the upper surface 3 is shown as having been metallized such that it supports a layer of metal 5 thereon for providing a metallized diamond layer 7 having a metal surface 10. The metallization as depicted in FIG. 2 may be effected in accordance with the present invention by providing an adhesion layer 6 onto the diamond layer's upper surface 3, and then by providing a layer of metal 5 on the adhesion layer. Providing the layer of metal 5, according to one embodiment of the present invention, comprises either sputtering or metal plating on top of the adhesion layer, as readily recognized by one skilled in the art, although other methods within the knowledge of a person skilled in the art are also possible. The adhesion layer 6 may comprise a metal sputtered onto the rough upper surface 3 of diamond layer 1, the metal having the characteristic of adhering to diamond. A role of the adhesion layer is to enhance adhesion of the layer of metal to the diamond layer. The sputtering of the adhesion layer according to embodiments of the present invention may involve applying a negative charge to a target, such as a Ti target, in a vacuum chamber. Positive Ar ions may then be used to bombard the Ti target, knocking off atoms of the target material, which then adhere to the diamond by forming carbides therewith. Other methods of providing the adhesion layer and the layer of metal, including other sputtering methods, are within the knowledge of a person skilled in the art. According to one embodiment of the present invention, the metal sputtered onto the diamond layer 1 as the adhesion layer 6 is Ti, but other metals, such as Cr, Fe, Si or Mo, which tend to form carbides with the diamond, may also be used.

The decision as to what material or materials would then be provided on top of the adhesion layer in embodiments of the present invention depends on a number of factors. For example, a barrier layer may be provided between the adhesion layer and the layer of metal 5 to keep material from the adhesion layer to diffuse into the layer of metal 5, as will be explained in more detail in relation to FIG. 5 below. Alternatively, as seen in FIG. 2, the layer of metal 5 may be directly provided on the adhesion layer. In either of the above two alternatives, according to one embodiment of the present invention, either the adhesion layer or the barrier layer may be provided with one or more layers of Au, Ni or Ag thereon to provide the layer of metal 5, by sputtering or plating or any other conventional deposition method. Embodiments of the present invention include within their scope, however, the use of any other suitable metal in the layer of metal 5 that has a thermal conductivity that makes it suitable for use in a heat spreader, as readily recognizable by one skilled in the art.

In the context of embodiments of the present invention, “thermal coupling surface” refers to a surface of the diamond integrated heat spreader that is to be brought into direct attachment to a thermal interface material for incorporation into a heat spreader package. For example, where the thermal interface material includes solder, according to one embodiment of the present invention, the thermal coupling surface may comprise an Au surface, whereas, where the thermal interface material includes a polymer or gel, the thermal coupling surface may comprise a Ni surface. The reason for the above is that, since Au does not have a native surface oxide, it can easily form an intermetallic bond with solder. However, Ni exhibits a significant native Ni oxide covering on its surface that precludes an effective bond with solder. Therefore, Ni is sometimes coated with Au to allow the bonding with solder. In the alternative, a polymer thermal interface material can interact with the Ni oxide via dipole interactions forming a chemical bond, and seep into the pores of the Ni oxide layer forming a mechanical bond. Since Au does not exhibit a metal oxide layer, any adhesion of the same with solder would yield a very weak bond, and would thus be undesirable. Examples of polymer thermal interface materials include thermal grease, phase change materials, gels, and poly-solder hybrids, as recognized by one skilled in the art.

The layer of metal 5 is polished according to embodiments of the present invention as described in more detail with respect to FIG. 3. The polished layer of metal 5 may then be either directly attached to a thermal interface material, or it may be attached to a thermal interface material through a final layer provided thereon, as will be described in further detail with respect to FIG. 4 below. If no final layer is provided on the layer of metal 5, then, polished upper surface 11 (see FIG. 3) of the layer of metal 5 will provide the thermal coupling surface. However, if a final layer is provided on the layer of metal 5 (see FIG. 4), then, a smooth upper surface 16 of the final layer 15 will provide the thermal coupling surface.

The thickness of the metal layer 5 over the rough upper surface 3 of diamond layer 1 is chosen based on the roughness of the upper surface 3. Here, the metallized diamond layer 7 has been polished to yield a polished metallized diamond layer 9 exhibiting polished upper surface 11 of the layer of metal 5. The layer of metal 5 is shown as having been polished to a desired flatness and roughness. For a diamond integrated heat spreader, the RMS roughness of the metal surface 11 may be about 10 microns or less, and its flatness may be in the order of about 1.5 mil (10⁻³ inch) per inch. Any number of layers may be plated over the adhesion layer to achieve the desired thickness for the layer of metal 5 according to embodiments of the present invention. It is noted that, although the layer of metal 5 is depicted in FIG. 2 as a single layer, it may involve one or more layers as described above. In general, an embodiment of the present invention contemplates the provision of a minimum number of layers on the diamond layer just enough to cover the roughness thereof.

Referring thereafter to FIG. 4, the polished metallized diamond layer 9 of FIG. 3 may be further processed by being provided with a final layer according to one embodiment of the present invention. The above step yields a coated polished metallized diamond layer 13. A purpose of providing the final layer is to provide the diamond layer 15 with a supplemental layer that would allow the diamond layer to be thermally coupled to a heat sink depending on the thermal interface material to be used, as readily recognized by one skilled in the art, and as explained above. The final layer may comprise a layer of metal, and the provision of the final layer may be effected using known methods such as plating or sputtering, with either Au, Ag or Ni, or any other suitable material depending on the thermal interface material to be used, as readily recognizable by one skilled in the art. Another suitable material for the final layer includes Cu, although it is noted that both Ag and Cu corrode relatively easily when compared with Au or Ni. Although the choice of thermal interface material influences the type of material to be used to provide the thermal coupling surface, another consideration in choosing the material that provides the thermal coupling surface is hardness and corrosion resistance, and, in particular, whether the thermal coupling surface is made of a material that is resistant to environmental elements, fingerprints or possible dents from handling, as readily recognizable by one skilled in the art.

Optionally, as depicted in particular in FIG. 5 and as briefly mentioned above, a barrier layer 18 may be provided according to one embodiment of the present invention between the adhesion layer 6 and the layer of metal 5 to form a diamond heat spreader 14. By way of example, where the layer of metal 5 comprises Au and the adhesion layer comprises Ti, the barrier layer may comprise one or more layers of platinum that would serve as a barrier to keep the Ti from diffusing into the Au. Alternatively, where the layer of metal 5 comprises Ni, the barrier layer may comprise one or more layers of Pt. The barrier layer 18 may be provided according to any one of known methods, such as sputtering or plating, as readily recognizable by a person skilled in the art.

In the context of embodiments of the present invention, the expression “covering layer” will be used to refer to the totality of the layers on the diamond layer adapted to be directly attached to a thermal interface material. For example, the covering layer for the embodiment of FIG. 4 would encompass the final layer 15, the polished layer of metal 5 (including any number of metal layers based on application needs), and the adhesion layer 6. In turn, in the embodiment of FIG. 3, the covering layer would encompass the layer of metal 5 and the adhesion layer 6. Regarding FIG. 5, the covering layer would encompass the polished layer of metal 5, the barrier layer 18, and the adhesion layer 6. An embodiment of the present invention contemplates the provision of as few layers as possible on the upper surface 3. The thickness of all of the layers combined into the covering layer, including the layers in the layer of metal 5, may, according to embodiments of the present invention, be such that the covering layer is thicker than the roughness of the upper diamond surface being covered. The covering layer may thus be thick enough to fill in the roughness of the diamond surface and thick enough to be polished flat, as readily recognizable by one skilled in the art.

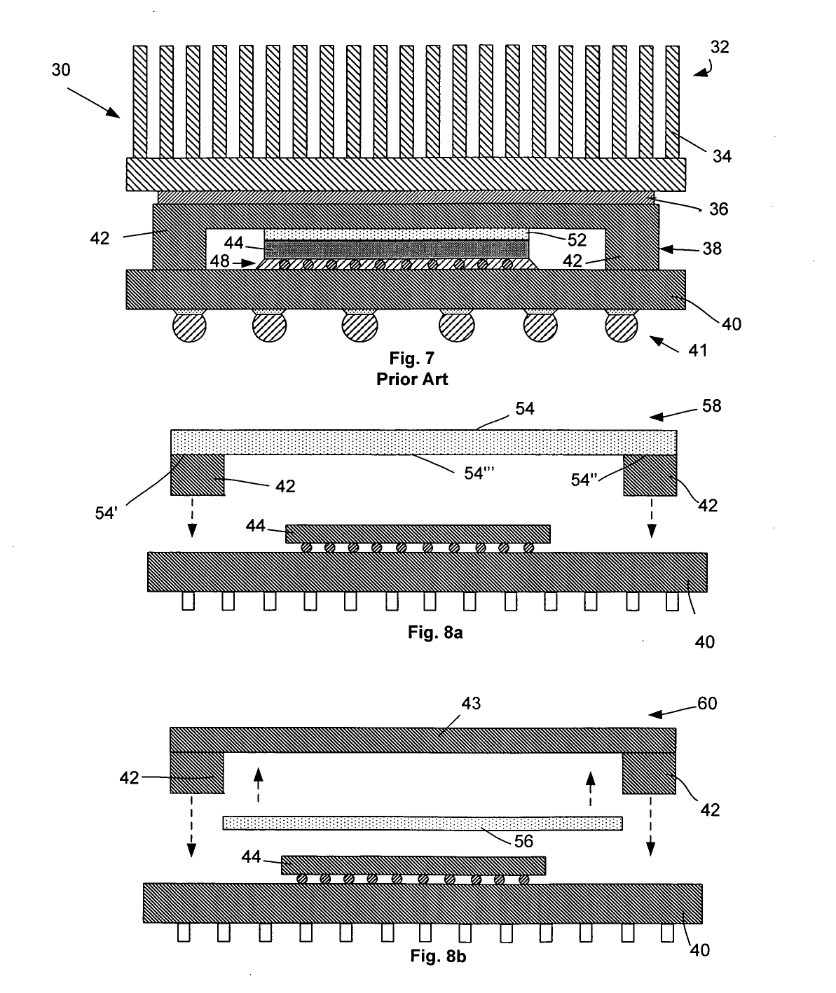

It is noted additionally with respect to the thermal coupling surface of a covering layer according to embodiments of the present invention that this surface need not necessarily be uniformly made of the same material. Thus, according to one embodiment of the present invention, the thermal coupling surface may include a surface made of different materials selectively provided on the diamond layer based on application needs, for example as a function of the thermal interface material to contact any given portion of the thermal coupling surface. An example of thermal coupling surface of different materials is discussed further below with respect to FIG. 6c, and in more detail with respect to FIGS. 8a and 8b below. To create a thermal coupling surface made of different materials, any number of known techniques may be used, as readily recognizable by a person skilled in the art. For example, a given diamond layer may be masked on pre-selected surfaces thereof and plated only on its exposed surfaces by being entirely submerged into one plating tank, and thereafter masked on the plated surfaces and entirely submerged into another, different plating tank to plate the previously masked surfaces thereof. For double-sided diamond heat spreaders, a diamond layer may be partially submerged into a plating tank to plate one surface thereof, and then partially submerged into another, different plating tank to plate the opposite surface thereof. Other techniques are within the knowledge of one skilled in the art.

While FIGS. 1-5 depict stages for the manufacturing of a diamond integrated heat spreader according to specific embodiments of the present invention, it should be noted that the present invention encompasses within its scope many variations of the above described processes. Details as to how the surface of the predetermined roughness is provided on the diamond body may vary according to application needs, an exemplary set of details having been set forth above with respect to processes according to embodiments of the present invention. Embodiments of the present invention obviate the need to polish a surface of the diamond body by providing a covering layer thereon such that the covering layer provides a thermal coupling surface of the desired characteristics, such as, for example roughness and flatness.

Additionally, as noted above, embodiments of the present invention encompass the processing of both upper and lower surfaces of a diamond layer exhibiting double-sided roughness, as depicted in FIGS. 6a-6c. By “double-sided diamond heat spreader,” what is meant in the context of embodiments of the present invention is a diamond heat spreader having both an upper side and a lower side thereof be provided with a covering layer having a predetermined roughness and flatness as described by way of example with respect to FIGS. 1-5.

As seen in FIG. 6a, an embodiment of a diamond heat spreader 17 according to the present invention includes a polished upper surface 19 and a polished lower surface 21, surfaces 19 and 21 serving as the thermal coupling surfaces of the diamond heat spreader 17. The diamond heat spreader 17 of FIG. 6a may be manufactured according to the embodiment of FIGS. 1-3, the process being applied to each of the upper and lower sides of a diamond layer 1, each of the upper and lower sides of the diamond layer initially exhibiting roughness as shown in FIG. 1. As seen in FIG. 6b, another embodiment of a diamond heat spreader 23 according to the present invention includes an upper surface 22 and a lower surface 24 serving as the thermal coupling surfaces of the diamond heat spreader 23. The diamond heat spreader 23 of FIG. 6b may be manufactured according to the embodiment of FIGS. 1-4, and includes final layers 15 on each side thereof. As with the embodiment of FIG. 5, the diamond heat spreaders of FIGS. 6a and 6b may optionally be provided with a barrier layer 18 (as seen in FIG. 5) between the adhesion layer and the layer of metal 5 on each side of the diamond layer.

Other embodiments of FIGS. 6a and 6b include a diamond heat spreader having an upper side and a lower side that have different layering configurations. For example, as seen in FIG. 6c, a diamond spreader 25 according to one embodiment of the present invention may have an upper side 27 that has the configuration shown in FIG. 4, and lower side 29 having a different configuration, such as the configuration of FIG. 5.

Different configurations for the upper and lower side of a double-sided diamond spreader according to embodiments of the present invention are a function of the end use of the diamond spreader, and, among other things, a function of the thermal interface material to be attached to respective thermal coupling surfaces of the double-sided diamond spreader. For instance, as noted above, where solder is the thermal interface material on one side of the diamond spreader, and a polymer or gel is the thermal interface material on the opposite side of the diamond spreader, the thermal coupling surface on the solder side of the diamond spreader may comprise Au, while the thermal coupling surface on the opposite, polymer or gel side of the diamond spreader may comprise Ni.

Referring in particular to the thermal coupling surface 27 of the diamond heat spreader 25 of FIG. 6c, this surface includes three sections 27′, 27″ and 27′″. By way of example, surfaces 27′ and 27″ may be made of Ni for attachment to thermal epoxy, and surface 27′″ may be made of Au for attachment to solder. The opposite side of the diamond spreader is shown as having the configuration of FIG. 5, comprising, by way of example, Ni, without a final layer 15 thereon. The above exemplary embodiment being depicted in FIG. 6c, it is noted that embodiments of the present invention encompass other combinations of double-sided diamond spreader configurations depending on application needs, as readily recognized by one skilled in the art.

A diamond integrated heat spreader according to embodiments of the present invention may be especially suited for high-end server markets, where cost constraints may not be as critical as in the case of desktop markets, and where die power non-uniformity in the current state of the art is underscoring the need for higher performance heat spreaders. While, based on current power maps, diamond spreaders alone have been shown to reduce the overall junction to air resistance of a heat spreader by at least about 10%, the typical thickness ranges of the covering layer on diamond heat spreader according to embodiments of the present invention would not be such that they would appreciably reduce the above-noted performance gain.

FIG. 7 shows a microelectronic package 30 including a heat spreader assembly 32 according to the prior art. The heat spreader assembly 32 includes a heat sink 34 thermally coupled via a thermal interface material 36 with a load distribution lid 38. The load distribution lid, as is well known, has as one of its function the distribution of load from the heat sink onto the organic land grid array (OLGA) 40 having a ball grid array 41. The load distribution lid 38 further has a load bearing perimeter 42 that is secured to the OLGA 40 by an adhesive, such as epoxy or the like. The OLGA 40 is electrically and thermally coupled to the die 44 in a conventional manner via solder bumps and an epoxy layer 48. A thermally conductive layer 52 thermally couples the die 44 to the lid 38. By way of example, the lid may be made of Cu or Al or an aluminum silicon carbide material, and may be plated with Ni in order to guard against corrosion and wear. The heat spreader package in FIG. 7 encompasses thermally conductive layer 52, lid 38, thermal interface material 36 and heat sink 34. The package 30 shown in FIG. 7 is typical of packages in which a diamond heat spreader according to the present invention may be utilized, as described in the exemplary embodiments of FIGS. 8a and 8b.

Referring next to FIGS. 8a and 8b, different embodiments are shown for the incorporation into a microelectronic package of a double-sided diamond heat spreader according to embodiments of the present invention. It is noted that the diamond heat spreaders 54 and 56 shown in FIGS. 8a and 8b have been schematically shown in those figures as blocks. However, it is to be understood that the diamond spreaders 54 and 56 may have any double-sided configuration as described by way of example with respect to FIGS. 6a-6c above.

Referring to FIGS. 8a, the diamond heat spreader 54 serves as an upper lid portion of a load distribution lid 58 that is comparable to lid 38 of FIG. 7. Perimeter 42 may be made of the same materials as set forth by way of example with respect to lid 38 of FIG. 7, the perimeter being attached to the diamond heat spreader via any suitable adhesive, such as epoxy. If epoxy or a polymer or gel adhesive is used to attach perimeter 42 to diamond heat spreader, the perimeter may be plated with Ni, and the underside of the diamond heat spreader 54 may present surfaces made of Ni at least on the surfaces 54′ and 54″ that are to be contacted by the epoxy or polymer or gel adhesive. Surfaces 54′ and 54″ may both be part of the same perimeter surface of the lower surface of the diamond heat spreader 54. By way of example, the central lower surface 54′″ of diamond heat spreader 54 may be plated with Au for attachment to the die 44 by way of solder. In this respect, the lower surfaces 54′, 54″ and 54′″ of diamond heat spreader 54 may exhibit the same configuration as that of thermal coupling surface 27 of diamond heat spreader 25 of FIG. 6c described above. The upper thermal coupling surface of the diamond heat spreader 54 may be made of any suitable material based on the thermal interface material to be used for the attachment of the diamond heat spreader 54 to a heat sink, such as heat sink 34 of FIG. 7. This upper surface may, by way of example, have the configuration of lower surface 29 of diamond heat spreader 25 shown in FIG. 6c.

Referring next to FIG. 8b, a different embodiment than that shown in FIG. 8a is for a double-sided diamond heat spreader 56 according to the present invention. Here, instead of serving as the top portion 43 of a load distribution lid 60 as was the case in the embodiment of FIG. 8a, the diamond heat spreader 56 is attached to the lower surface of the lid 60 as shown. Lid 60 includes a perimeter 42 and a top portion 43 as shown, and may be made as described above in relation to lid 38 of FIG. 7. The surface configuration of the diamond heat spreader 56 would then depend on the thermal interface material used to attach the heat spreader to the die 44 on the one hand, and to the top portion 43 of lid 60 on the other hand, as readily recognizable by a person killed in the art.

Embodiments of the present invention further encompass a diamond heat spreader comprising a diamond layer; and means adhered to at least one surface of the diamond layer for providing at least one respective thermal coupling surface of the heat spreader. An example of the means is shown in FIG. 1-6c. Other means would be within the knowledge of a person skilled in the art.

The invention has been described with reference to specific exemplary embodiments thereof. It will, however, be evident to persons having the benefit of this disclosure, that various modifications and changes may be made to these embodiments without departing from the broader spirit and scope of the invention. The specification and drawings are, accordingly, to be regarded in an illustrative rather than in a restrictive sense.

1-17. (canceled)

18-30. (canceled)

31. A method of providing a heat spreader comprising:
providing a flat surface;
providing a diamond layer onto the flat surface using chemical vapor deposition;
providing a covering layer onto a free surface of the diamond layer, the covering layer comprising a layer of metal and having a thermal coupling surface adapted to adhere to a thermal interface material; and
polishing the layer of metal to yield a polished layer of metal.

32. The method of claim 31, wherein polishing comprises polishing to a flatness of about 1.5 mil per inch.

33. The method of claim 31, wherein polishing comprises polishing to a RMS roughness that is less than or equal to about 10 microns.

34. The method of claim 31, wherein the polished layer of metal has a thickness that is less than or equal to about 10 microns.

35. The method of claim 31, wherein the covering layer further comprises a final layer onto the polished layer of metal.

36. The method of claim 35, wherein the final layer comprises at least one of Au, Ag, Cu and Ni.

37. The method of claim 35, wherein providing a covering layer comprises metal plating the polished layer of metal to obtain the final layer.

38. The method of claim 31, wherein providing a covering layer comprises one of sputtering and metal plating to obtain the layer of metal.

39. The method of claim 31, wherein providing a covering layer comprises providing an adhesion layer directly onto the free surface.

40. The method of claim 39, wherein providing a covering layer further comprises providing a barrier layer between the adhesion layer and the layer of metal.

41. The method of claim 39, wherein the adhesion layer comprises one of Ti, Cr, Fe, Si and Mo.

41. The method of claim 31, wherein the thermal coupling surface has regions made of different metals.

42. A method of providing a heat spreader package comprising providing a heat spreader comprising:
providing a flat surface;
providing a diamond layer onto the flat surface using chemical vapor deposition;
providing a covering layer onto a free surface of the diamond layer, the covering layer comprising a layer of metal and having a thermal coupling surface adapted to adhere to a thermal interface material; and
polishing the layer of metal to yield a polished layer of metal; and
thermally coupling a heat sink to the heat spreader.

43. The method of claim 42, further comprising thermally coupling a load distribution lid to the heat sink and to the diamond heat spreader.

44. The method of claim 42, further comprising connecting a load distribution perimeter to the heat spreader to form a load distribution lid thermally coupled to the heat sink.
